(19) United States
(12) Patent Application Publication
(10) Pub. No.: US 2018/0042318 A1
(43) Pub. Date: Feb. 15, 2018

(54) PLASTIC BAG WITH GLOVES

(71) Applicant: lndarjit Jagnarine, Palm Beach Gardens, FL (US)

(72) Inventor: Indarjit Jagnarine, Palm Beach Gardens, FL (US)

(21) Appl. No.: 15/232,983

(22) Filed: Aug. 10, 2016

(51) Int. Cl. A41D 19/00; B65D 33/01; B29C 65/70; B29C 65/48; B29C 65/02; B29C 65/08; B65D 33/25; B65D 33/24

(52) U.S. Cl. CPC A41D 19/0075; B65D 33/2591; B65D 33/01; B65D 33/24; A41D 19/0037; B29C 65/48; B29C 65/02; B29C 65/08; B29C 65/70; B29K 2023/0633

(57) ABSTRACT

A device comprises a bag comprising a non-porous material. The bag has a plurality of edges. The device has at least one glove with an open end. The open end has a perimeter. The perimeter is integrally joined to the non-porous material along one of the plurality of edges. The at least one glove is positionable inside the bag, with the open end of the glove facing out of the bag. The bag has a closure capable of forming a seal when the closure is closed.

### FIELD

The present disclosure relates to flexible plastic storage bags and storage compartments.

### BACKGROUND

Today, people are paying increasing attention to their health by preparing and cooking more fresh foods at home. According to the United States Department of Agriculture (USDA), food that is mishandled can lead to foodborne illnesses. The Center for Disease Control (CDC) reports that each year 1 in 6 Americans (or 48 million) gets sick by consuming contaminated food or beverages, and there are more than 250 different illnesses caused by a variety of pathogens (bacteria, viruses and parasites) that can be foodborne. Illness-causing pathogens can survive and grow in many places such as on hands, under fingernails, on utensils, cutting boards and countertops, and can spread to ready-to-eat foods unless they are kept separate during preparation and handling. Illness causing pathogens can also be transferred to faucets, countertops, sinks, and utensils from splashing during cutting and slicing.

During the food handling process, to prevent the spread of foodborne illnesses everything that comes in contact with raw foods should be kept clean for food safety. Generally, food groups such as meat, vegetables and fruit are kept separate. Food preparers keep their hands, countertop and sink from coming into direct contact with the raw foods as much as possible, and wash hands with warm water and soap throughout the cooking process especially after handling raw meat and poultry. According to the Food and Drug Administration (FDA) washing hands may not always be enough and recommends the use of barrier protection to stop the spread of germs.

Additionally, many individuals are performing tasks that expose them to toxic chemicals such as paints and adhesives. According to research conducted by the United States Environmental Protection Agency (USEPA EPA, Indoor Air Quality), about a dozen common organic pollutants were found to be 2 to 5 times elevated levels inside homes. Furthermore, the research indicated that “while people are using products containing organic chemicals, they can expose themselves and others to very high pollutants levels, and elevated concentrations can persist in the air long after the activity is completed”. Volatile Organic Chemicals (VOCs) are present in many household products such as paints, nail polish, sprays and cosmetic products which can release toxic substances into the indoor home environment when used.

In tasks such as painting and gluing, masks are often worn and the activity may be conducted in a well-ventilated area to avoid inhaling toxic chemicals.

Flexible plastic bag type containers are commonly used for storing and preserving foods and other products. Plastic container type bags serve as an inexpensive barrier to help prevent the spread of illness-causing pathogens and protection from environmental contaminants as discussed above.

### SUMMARY

In some embodiments, a device comprises a bag comprising a non-porous material. The bag has a plurality of edges. The device has at least one glove with an open end. The open end has a perimeter. The perimeter is integrally joined to the non-porous material along one of the plurality of edges. The at least one glove is positionable inside the bag, with the open end of the glove facing out of the bag. The bag has a closure capable of forming a seal when the closure is closed.

In some embodiments, a device comprises a container having a front face and a rear face aligned one above the other. Each of the front face and the rear face have a respective first edge, second edge, third edge, and fourth edge. The respective second edges are opposite the respective first edges. The first edge of the front face is joined to the first edge of the rear face. The second edge of the front face is joined to the second edge of the rear face. The device has at least one glove with an open end defining an opening having a perimeter. The at least one glove is integrally attached to the third edges of the front face and the rear face along the perimeter of the opening, such that the third edge of the front face is joined to the third edge of the rear face, except along the perimeter. The at least one glove is positionable between the front face and the rear face. The device has a closure, at or near the fourth edge of the front face. The closure is closable to seal the container.

In some embodiments, a method of making a device comprises:

(a) configuring a sheet material with a front face and a rear face, the front face joined to the rear face along at least a first edge of the front face and a first edge of the rear face;
(b) sealingly joining a glove material along a perimeter of an open end of at least one glove to a second edge of the front face and a second edge of the rear face; and
(c) providing a closure for reversibly sealing a third edge of the front face to a third edge of the rear face.

In some embodiments, a method of making a device comprises:

(a) providing a unitary front film including a front bag face and at least one front glove face integrally attached to at least one edge of the front bag face; (b) providing a unitary rear film including a rear bag face and at least one rear glove face integrally attached to at least one edge of the rear bag face; (c) sealingly joining a perimeter of the front film to a perimeter of the rear film, except along a closure edge of the front film and a closure edge of the rear film; and (d) joining a closure to the closure edge of the front film and the closure edge of the rear film for reversibly sealing the device.

### BRIEF DESCRIPTION OF THE DRAWINGS

FIG. 1 is front isometric view of a device in accordance with some embodiments.

FIG. 2 is a plan view of one of the gloves of FIG. 1.

FIG. 3 is an isometric view showing a method of joining gloves to a bag according to some embodiments.

FIGS. 4A and 4B show an alternative method of making the device of FIG. 1.

FIG. 5 is a plan view of a device according to another embodiment.

FIGS. 6a and 6b shows an embodiment of a device including a hook and loop fastener.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Unless otherwise indicated, like elements and components are indicated by the same designations and numbering throughout the drawings.

The drawings are not to scale.

Food storage bags and containers can prevent the spread of germs to the environment during storage, but risk of contamination remains when the food is removed from the containers for cooking. Food preparation personnel may not always properly wash their hands and/or wear protective gloves during the entire food handling process, facilitating the spread of germs. In addition, contaminated gloves can be accidentally used to touch other foods, surfaces and utensils resulting in cross contamination and the spread of germs. During raw food handling and preparation, the presence of illness causing pathogens is unseen to the naked eye and can be transferred from one surface to another without the user's knowledge. For example, if one touches raw meat and then goes on to prepare salad without washing hands the pathogens from the meat can be transferred to the salad and can make a person ill.

In some embodiments described herein, a device provides dual barrier protection, eliminating direct contact between the user's hands and a work piece (e.g., food) during handling and preparation of the work piece, and also eliminating direct contact between the work piece and the external environment during handling, preparation and storage.

Some embodiments described herein enable a user to handle or perform various tasks with the user's hands and the work piece (e.g., food) inside a closed flexible bag, while preventing the hands from coming into direct contact with, or being exposed to, the contents inside the bag. The closed bag also prevents the contents inside the bag from coming into contact with the external environment for purposes of hygienic safety, cleanliness, convenience and prevention of exposure to odiferous foods and chemicals.

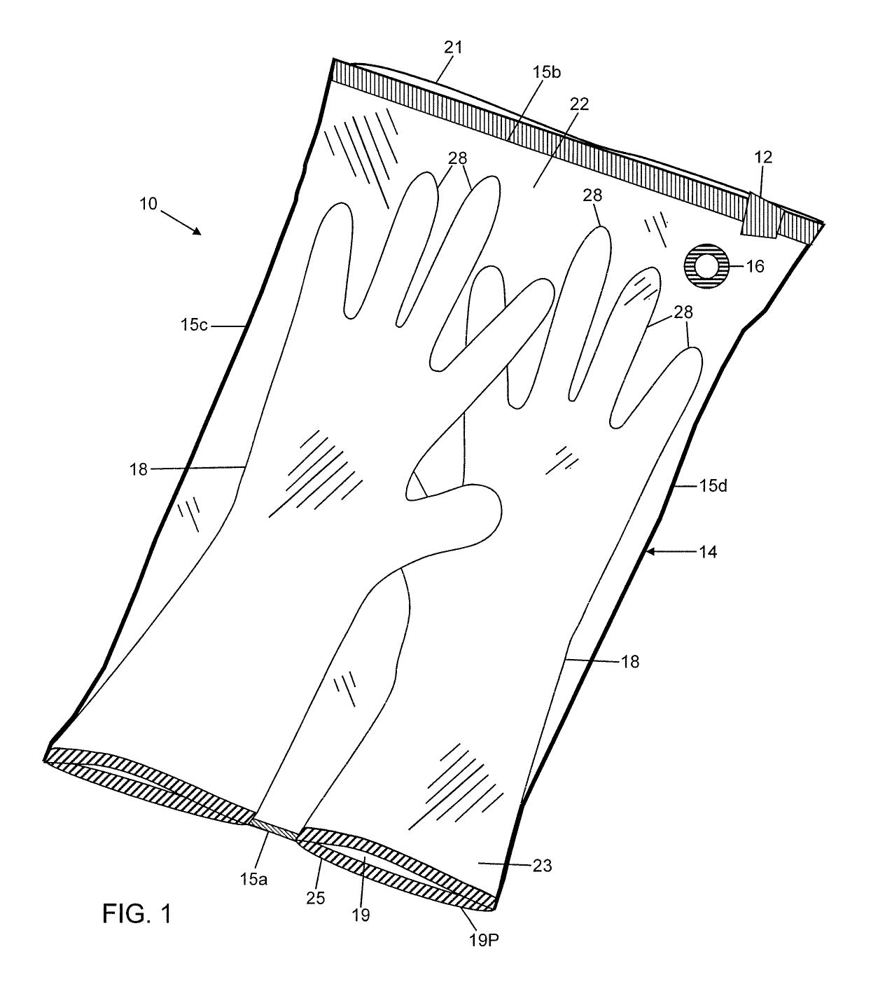

FIG. 1 is an isometric view of a device 10 according to some embodiments. Device 10 includes a plastic bag or container 14 and a glove component 18 that is located inside and integrally bonded to the plastic bag-type container 14. The integral bag-glove assembly of device 10 allows a person to perform various tasks with flexibility and dexterity while providing hygienic safety and preventing exposure to environmental contaminants.

FIG. 1 shows the bag 14 with attached gloves 18 permanently and integrally attached to the bag 14, and positioned between the front face 22 and rear face 21 of the bag 14, on the end 15a of the bag 14 opposite the end 15b having the closure 12 of the bag 14. The front face 22 and rear face 21 of bag 14 can be made of a transparent, impermeable material such as low density polyethylene or other suitable material. The contact points between the front face 22, rear face 21, and glove(s) 18 can be formed, so that when the closure 12 and, when present, the valve 16 are sealed, the working volume within the bag 14 is air-tight.

As shown in FIG. 1, the glove component 18 can have a front face 23 and rear face 25. The glove 18 has an open end 19 with a perimeter 19P, and a plurality of fingers 28 at a closed end opposite the open end 19. As shown in FIG. 1, the glove 18 is inside the bag 14 and under the front face 22 of the bag 14.

Also shown in FIG. 1, one end 15b of the plastic bag 14 is closable by means of a closure (e.g., plastic zipper type closure 12) providing a barrier between the inside of the bag and the outside of the bag, On the end 15a opposite the closable end 15b, a pair of gloves 18 are permanently and integrally attached to bag 14 as described below. The flexible closable bag 14 comprises a front face 22 and a rear face 21. Thus, the plurality of edges of the bag 14 includes a first edge 15a and a second edge 15b opposite the first edge 15a, the open end 19 of the glove is integrally attached to the first edge 15a, and the closure 12 is on or adjacent the second edge 15b.

In some embodiments, a pair of disposable gloves 18 is integrally attached to a plastic bag type container 14 that allows a person to perform a variety of tasks within the container 14, such as but not limited to: slicing and cutting raw foods, preparing raw meat, making beef patties, slicing onions, seeding a pomegranate, peeling shrimp, painting Easter eggs, seeding messy fruits (e.g., pomegranates), or carving a pumpkin. Devices 10 according to various embodiments described herein have a wide array of other applications that are not limited to food preparation. Other examples of uses include tasks using volatile or toxic materials, such as paint, glue, varnish, solvents, scents, gasoline, or the like. For example, device 10 can be used for painting a small stool, polishing shoes or assembling plastic parts using model airplane glue.

Some embodiments allow the user to conduct the above tasks while maintaining a first protective barrier 18 between the hands and the work piece inside bag, while maintaining a second protective barrier 14 between the work piece and the external environment.

In some embodiments, the container is in the form of a bag 14. The bag can be configured in the form of two planar films folded and/or joined at the edges (as in a food storage bag), a five-sided sack configuration, or other shape.

In some embodiments, the bag 14 and gloves 18 are made exclusively of the same material, and the device can have a unitary structure. The bag 14 and gloves 18 can be made of low density polyethylene or other plastic or rubber, depending on expected usage and content inside bag compartment 14. In some embodiments, the bag 14, gloves 18 and valve 16 are all disposable and are made of a transparent, non porous, food grade plastic, such as polyethylene, polyvinyl chloride (PVC), low density polyvinyl chloride, polyvinylidene chloride, urethane, or the like.

In some embodiments, each face 14a, 14b of the bag 14 is a single layer film. In other embodiments, each face 14a, 14b is a multilayer film laminate. If a multilayer film laminate is used, the outside layers of both faces 14a and 14b are the same material as each other, and the inside layers of both faces 14a and 14b are the same material as each other.

In some embodiments, the bag 14 and gloves 18 are integrally formed from the same sheet material such as a film of one of the plastic materials listed in the preceding paragraph. The film can have a thickness in a range from 1 mil (0.0254 mm) to 3 mil (0.0762 mm). In some embodiments, the bag 14 and gloves 18 have the same thickness as each other. In other embodiments, the bag 14 and gloves 18 have different thicknesses.

In other embodiments, the bag 14 can be formed of a first material, and the gloves 18 can be formed of a second material different from the first material. The gloves 18 can be joined to the bag 14 by adhesion. Examples of suitable glove materials include, but are not limited to: rubber, nitrile, latex, vinyl, neoprene or polyethylene, polypropylene, or the like. Gloves can be made in many sizes, shapes, textures and colors. For example, the bag 14 can be made of low density polyethylene, and the gloves 18 can be made of nitrile rubber. Examples of suitable adhesives include silicone adhesives and pressure sensitive adhesives. Alternately, the materials can be adhered together by thermal bonding with or without an adhesive.

The bag 14 can be sized large enough for a user to place various sizes and types of cutting boards, flexible plastic cutting mats, knives and/or other utensils or tools into the bag 14 with food and/or other work piece and seal the bag 14 using the closure 12 for performing a task. In some embodiments, the bag component 14 is sufficiently large to contain the user's gloved hands, the work piece (e.g., a food item), a cutting board, and one or more food preparation utensils, such as knives, forks, spoons, peelers, or the like.

In some embodiments, the flexible bag 14 comprises an interior volume for containing food and/or other items and a closable mouth at the top end 15b for accessing the interior volume. A re-closable plastic zipper closure 12 or other locking closure (such as a “GLAD® SNAP LOCK®” closure from the Clorox Company, Oakland, Calif.) is provided on end 15b of the plastic bag 14 for placing food and/or other items in the bag 14 and for removing the item from the bag 14. U.S. Pat. Nos. 4,532,652, 5,839,582, and 7,029,178, and EP 1739024 are incorporated by reference herein in their entireties. These four patents describe other suitable closures 12 for use in bag 14.

Some embodiments further include an integrally attached air valve 16 to allow the user to inflate the bag 14 while the item is sealed in the bag. Inflating the bag 14 can enhance visibility and facilitate the user's manipulation of the item while the user's hands are within the gloves 18. The bag 14, gloves 18, re-closable plastic zipper closure 12 and air valve 16 can be fabricated of non-porous plastic material, rubber or other non-porous, flexible material so that there is no leakage of liquid during normal usage.

In some embodiments the air valve 16 is configured to permit inflation of the bag using a hand pump or electrical pump. In other embodiments, the air valve 16 is configured to allow the user to inflate the bag 14 by blowing into the valve 16. In addition, or alternately, the air valve 16 can be configured to allow for removal or air from the bag. Such embodiments can be particularly useful where the bag is used to store the item (e.g., food) within the bag.

In some embodiments, the front face 22 and rear face 21 are formed by folding a sheet of flexible plastic film and sealing the edges (by thermal fusion, ultrasonic welding or adhesion), forming a receptacle. In other embodiments, the front face and rear face are formed separately (e.g., by stamping the front and rear faces 22, 21 from a sheet of material), and joined together to form the receptacle 14. Then the closure 12 is joined to the front face 22 and rear face 21.

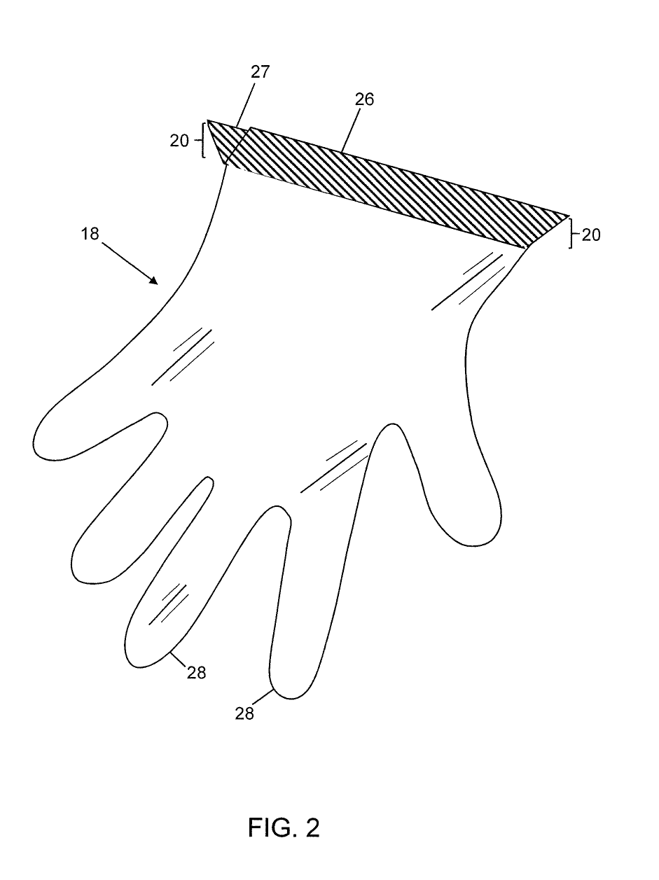

In some embodiments, the glove 18 and bag 14 are formed separately. For example, the bag 14 can be formed by cutting an opening 17 (or two separate openings) in the bottom end 15a of a food storage bag to receive the gloves 18. The gloves 18 can be previously manufactured gloves, such as medical examination gloves. A slit 20 about 1 inch (2.54 cm) wide is cut in the medial and lateral sides of the glove 18 at the mouth 19 of the gloves 18 as shown in FIG. 2. The glove material on front and rear sides of the slits 20 is spread apart, to form opposing front and rear flaps 26 and 27, respectively.

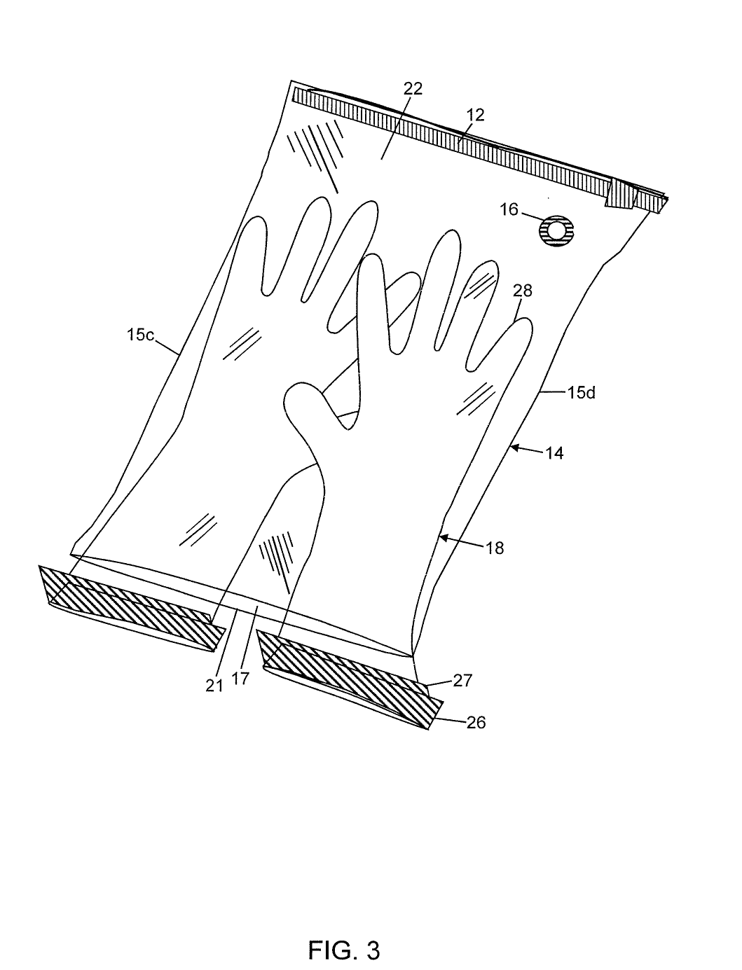

FIG. 3 shows the glove 18 component with flaps 26, 27 prior to attaching the glove 18 to the flexible plastic bag 14. The glove 18 is inserted in an opening 17 in the bottom edge 15a of the bag 14. The front flap 26 of glove 18 is sealingly joined to the marginal edge of the front face 22 of the bag 14 by means of adhesion, thermal fusion, or ultrasonic welding. The rear flap 27 of glove 18 is sealingly joined to the marginal edge of the rear face 21 of the bag 14 by means of adhesion, thermal fusion, or ultrasonic welding. After the gloves 18 are attached to the bottom edge 15a of the bag, the side edges 15c, 15d of the front face 22 and rear face 21 of bag 18 are joined, as shown in FIG. 3, and the portion of the front face 22 between the gloves 18 is joined to the corresponding portion of the rear face 21, and the closure 12 is attached to the top edge shown in FIG. 3,

In other embodiments, the bag 14 is provided by cutting separate left and right openings in the bottom edge 15a of a previously formed bag, so the step of bonding the portion of the front face 22 between the gloves 18 to the corresponding portion of the rear face 21 can be omitted.

FIGS. 14A and 14B show an alternative method for constructing the device 10. As shown in FIG. 14A, two separate planar unitary films 10a, 10b, are formed from a plastic material. A unitary front film 10a includes a front bag face 14a and at least one front glove face 18a integrally attached to at least one edge of the front bag face 14a. A unitary rear film 10b includes a rear bag face 14b and at least one rear glove face 18b integrally attached to at least one edge of the rear bag face 14b. In some embodiments, the unitary front film 10a and the unitary rear film 10b are formed by stamping or cuffing the films from a sheet. The front film 10a is placed over the rear film 10b in aligned relationship with edges of the front film 10a contacting the corresponding edges of the rear film 10b.

Once the films are aligned and contacting each other, a perimeter of the front film 10a is sealingly joined to a perimeter of the rear film 10b, except along a closure edge 14c of the front film 10a and a closure edge 14c of the rear film 14b. The front bag face 14a and rear bag face 14b form the bag 14. The films 10a and 10b can be joined by thermal fusion bonding or ultrasonic welding. The front glove face 18a and rear glove face 18b form the glove 18. A closure 12 is joined to the closure edge 14c of the front film 10a and the closure edge 14c of the rear film 10b for reversibly sealing the device 10.

At the time the films 10a and 10b are joined, the fingers 28 of gloves 18 extend away from the front bag face 14a and the rear bag face 14b, as shown in FIG. 14A and as shown by the solid lines in FIG. 14B,

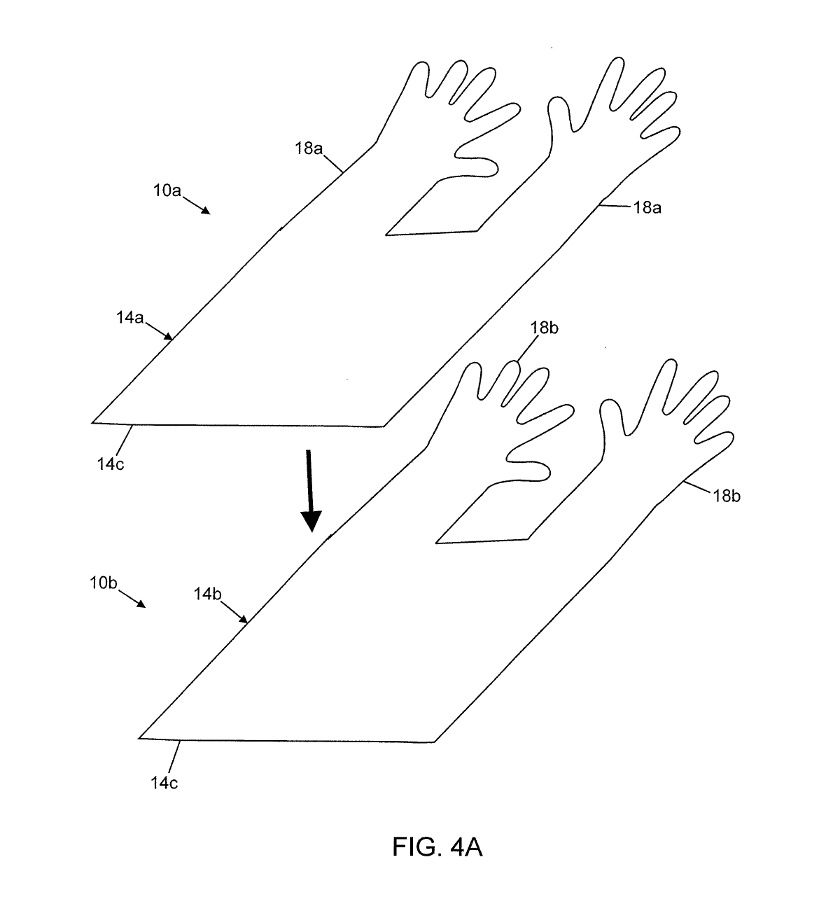

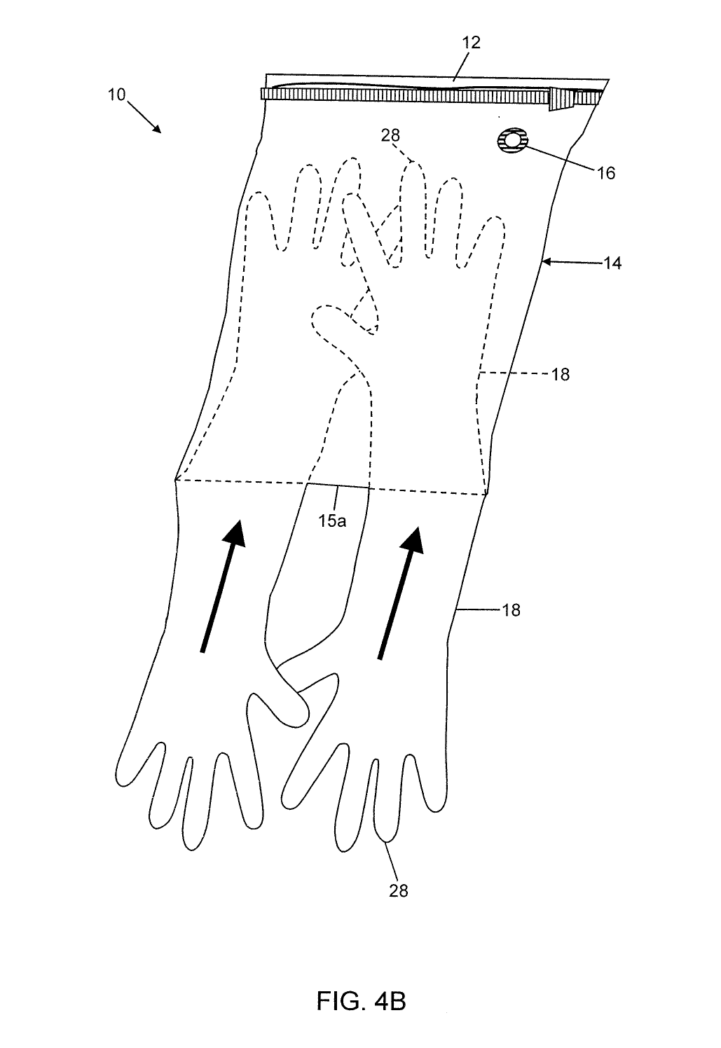

After joining the front film 10a and the rear film 10b, the gloves 18 are inverted so that the fingers 28 of the gloves 18 are located between the front bag face 14a and the rear bag face 14b, as shown in phantom in FIG. 4B. In some embodiments, the step of inverting the gloves 18 is performed by providing a vacuum at the valve 16, so as to pull the gloves into the bag, as shown in phantom. In other embodiments, the gloves 18 are pushed and/or pulled into the bag mechanically.

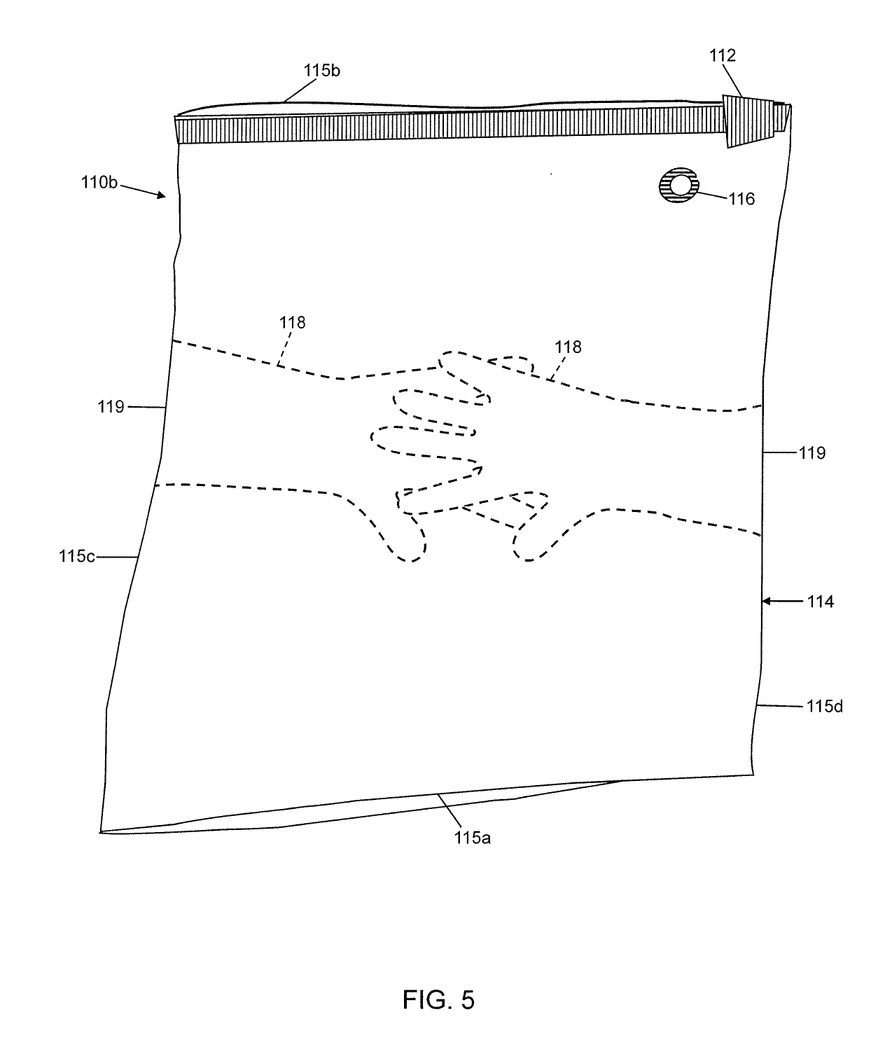

FIG. 5 is a plan view of another embodiment of the device 110, in which the user's arms can be inserted from opposite sides of the device. Reference numerals in FIG. 5 are the same as the reference numerals of corresponding items in FIG. 1, increased by 100. The device 110 includes a bag 114 or container and gloves 118, which can be made of the same materials as discussed above with respect to FIGS. 1-3. In device 110 the plurality of edges of bag 114 includes a first edge 115c, a second edge 115b, and a third edge 115d. The third edge 115d is opposite the first edge 115c. The second edge 115b is connected between the first edge 115c and the third edge 115d. The open ends 119 of the gloves 118 are integrally attached to the first edge 115c or the third edge 115d, and the closure 112 is on or adjacent the second edge 115b. The device as shown in FIG. 5 can be made using any of the techniques described above with reference to the embodiments of FIGS. 1-4.

In some embodiments, an air valve 16 assembly penetrates and is sealingly mounted in the front face 22 of the bag 14 for the insertion of air. Any suitable inflatable air valve 16 assembly may be used. In some embodiments, the air through valve 16 is configured to interface to hand or battery operated pumps. In other embodiments, the valve 16 is configured to permit a user to blow into the valve. During usage the bag receptacle 14 can be inflated sufficiently to separate the front face 22 from the rear face and provide a work space within the bag 14 for the task to be performed. For example, the bag can be inflated so that the user's hand within the glove is not touching either face of the bag while the user performs the operation. in some embodiments, the user can inflate the bag to about 75 percent of its capacity. In some embodiments, the glove 18 is made of the same material as the bag such as polyethylene. In various embodiments, the material for the bag and the material of the glove can be selected based on intended use. For example, the bag can comprise a low density polyethylene used for food grade bags. The gloves can comprise the same material, or the glove material can be selected to provide any desired combination of leakage protection, thermal protection, snug fit, flexibility, and/or dexterity.

The bag-glove assembly of device 10 can: prevent the spread of germs from hands and cooking surfaces, prevent the transfer of illness-causing pathogens from one surface to another and one food to another, avoid direct skin contact, reduce exposure to raw foods and other materials and substances and reduce the need to wash and rinse hands, sinks and countertops during food preparation.

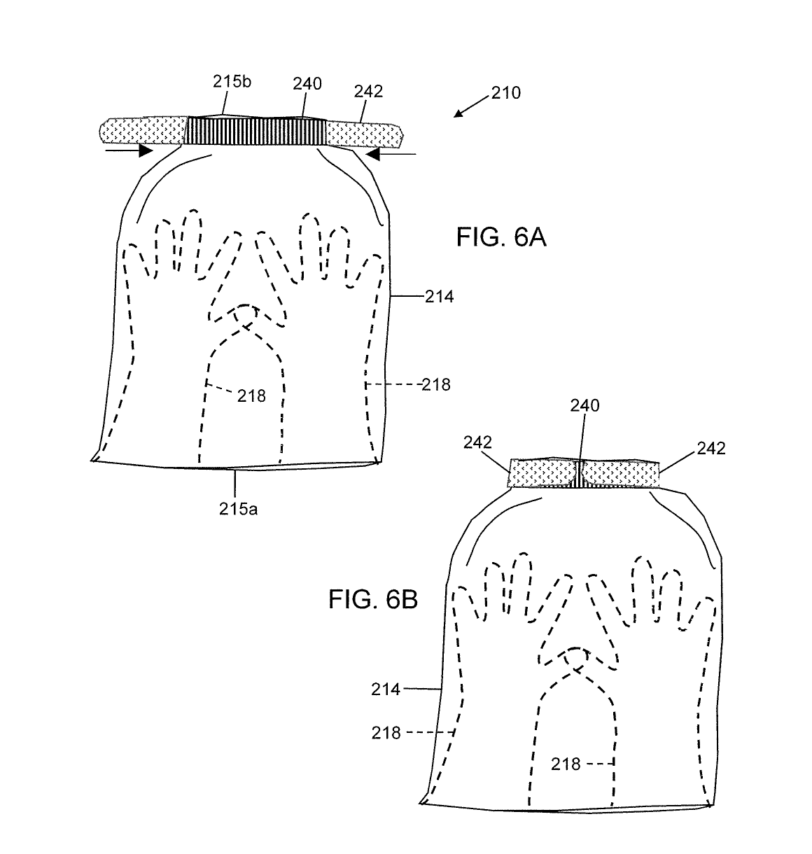

FIGS. 6a and 6b show another exemplary container 210 according to some embodiments. The container 210 has a hook 240 and loop 242 fastener (e.g., “VELCRO®” fastener sold by Velcro Limited of Cheshire, UK), an elastic band (not shown), or the like. The container 210 is suitable for tasks such as changing baby diapers, nail polishing and the like.

The hook 240 and loop 242 fastener can be secured like a belt securing device around a baby or child's waist for changing a diaper. The user can insert wet wipes, ointment, power or the like (not shown) inside the bag portion 214 of container 210, The hook 240 and loop 242 fastener is gently tightened around the waist. The user inserts her hands in the gloves 218 for cleaning the baby. The container 210 is helpful in a variety of settings when plumbing facilities are not available (e.g., on road trips in the car, at parks, or the like) since It is more sanitary and reduces odors. When the user has completed the diaper removal and cleaning, the wipes, the diaper and its contents are already contained within the bag 214 for disposal. The container 210 is disposable, and can comprise recyclable and non-porous plastic, such as the materials discussed above with respect to the container 10 of FIG. 1. The container 210 also protects the baby from contact with the waste, and from inhaling baby powder.

In another method of use, the container 210 can be used by a nail stylist or cosmetologist on the hands of an adult in the case of nail polishing. The stylist inserts the materials to be used (e.g., nail polish remover, nail polish, gloss, brushes, and the like) in the bag 214. In some embodiments, the stylist places activated carbon in the bag to absorb volatile gases within the bag. The client inserts her hands in the top end 215b of the bag 214, and the nail stylist gently closes the hook 240 and loop 242 fastener around the client's hands. The stylist inserts her hands in the gloves 218 for polishing the nails without exposing the stylist or the client to fumes. In addition to protecting the stylist and client from fumes, the container 210 prevents transmission of communicable diseases by direct hand contact between the stylist and client.

In another embodiment, the bag 10 has an access opening (not shown) on the front major face 22, such as the wrapper with reclosable seal described in U.S. Pat. No. 6,918,532 B2, which is incorporated by reference herein in its entirety (and sold as “SNACK 'N SEAL™” wrappers by Kraft Foods Holdings, Inc., Northfield, Ill.). In some embodiments, the film comprises a 0.7-mil metallized oriented polypropylene extrusion laminated to an extrusion lamination of 48-ga polyester and low-density polyethylene. A container 10 equipped with a reclosable seal (not shown) on the front face 22 is advantageous for a variety of applications, such as handling spices or chilies while cooking, slicing onions without tears, or the like.

In some embodiments, the sliced/chopped food is not removed from the bag, and is subsequently stored in the bag with the gloves. The integrally attached gloves are not used for preparing or handling other food or products, thus preventing cross contamination.

In some embodiments, the user's hands are removed from and re-inserted into the integrally attached gloves as often as desired (while the gloves stay attached to bag), to perform other tasks such as, but not limited to, preparing other foods, or answering phone without having to wash hands.

In some embodiments, the user can prepare and handle multiple raw foods in separate integral bag and glove units to prevent raw food groups (e.g. meat and salad) from coming into contact with each other, so as to prevent the transfer of germs.

In some embodiments, the integral bag-glove combination relieves a user from excessive need to wash hands with harsh soaps and chemicals, since the user's hands do not come into direct contact with food or other items inside the bag during preparation and handling.

In some embodiments, the integral bag-glove combination keeps countertops, utensils and sinks free from illness-causing bacteria since raw foods and other items are contained in a sealed bag during mixing, cutting, slicing, seasoning marinating and the like.

In some embodiments, the integral bag-glove combination conserves water during food preparation and handling by reducing the need for washing hands, countertops, sinks and utensils. Thus, the integral bag-glove combination can be used during food preparation and handling in areas lacking potable water.

In some embodiments, the integral bag-glove combination can be used for storing raw food waste within the sealed plastic bag for later disposal and also aid in preventing spillage of raw by-products from contaminated kitchen surfaces. For example, the user can peel and seed a fruit in the sealed bag, remove the fruit for consumption, reseal the bag, and store the peels and seeds in the bag for later disposal.

Although the examples above include food storage bags, various types, shapes and sizes of bags can be used, for various uses such as painting items, cleaning electronics equipment, painting Easter eggs or the like,

Other embodiments can include one or more items within the bag 14, such as a pouch with activated carbon, a desiccant, a thin plastic cutting mat, or the like.

Although the drawings show examples in which device 10 includes two gloves 18, other embodiments can include a single glove.

In in some embodiments, a second valve is provided in the front or rear face 22, 21 of the bag 14 to allow for the removal or air for food preservation. In some embodiments, the second value is adapted for attachment to a vacuum source.

Although the subject matter has been described in terms of exemplary embodiments, it is not limited thereto. Rather, the appended claims should be construed broadly, to include other variants and embodiments, which may be made by those skilled in the art.

What is claimed is:

1. A device comprising:
a bag comprising a non-porous material, the bag having a plurality of edges;
at least one glove having an open end, the open end having a perimeter, the perimeter integrally joined to the non-porous material along one of the plurality of edges, the at least one glove positionable inside the bag, with the open end of the glove facing out of the bag; and
the bag having a closure capable of forming a seal when the closure is closed.

2. The device of claim 1, wherein the bag and the at least one glove both comprise the same non-porous material.

3. The device of claim 2, wherein the non-porous material is a low density polyethylene.

4. The device of claim 1, wherein the closure is a plastic zipper closure.

5. The device of claim 1, wherein the closure is a plastic lock closure.

6. The device of claim 1, wherein the bag has an air valve on a front face or a rear face thereof.

7. The device of claim 1, wherein the plurality of edges includes a first edge and a second edge opposite the first edge, the open end of the glove is integrally attached to the first edge, and the closure is on or adjacent the second edge.

8. The device of claim 1, wherein:
the plurality of edges includes a first edge, a second edge, and a third edge,
the third edge is opposite the first edge,
the second edge is connected between the first edge and the third edge, and
the open end of the glove is integrally attached to the first edge or the third edge, and the closure is on or adjacent the second edge.

9. A device comprising:
a container having a front face and a rear face aligned one above the other, each face of the front face and the rear face having a respective first edge, second edge, third edge, and fourth edge, the respective second edges opposite the respective first edges, the first edge of the front face joined to the first edge of the rear face, the second edge of the front face joined to the second edge of the rear face;
at least one glove having an open end defining an opening having a perimeter, the at least one glove integrally attached to the third edges of the front face and the rear face along the perimeter of the opening, such that the third edge of the front face is joined to the third edge of the rear face except along the perimeter, the at least one glove positionable between the front face and the rear face;
a closure, at or near the fourth edge of the front face, the closure being closable to seal the container.

10. The device of claim 9, wherein the container and the at least one glove both comprise the same material.

11. The device of claim 9, wherein the closure is a plastic zipper closure.

12. The device of claim 9, wherein the closure is a plastic lock closure.

13. The device of claim 9, wherein one of the front face or the rear face has an air valve.

14. A method of making a device, comprising:
(a) configuring a sheet material with a front face and a rear face, the front face joined to the rear face along at least a first edge of the front face and a first edge of the rear face;
(b) sealingly joining a glove material along a perimeter of an open end of at least one glove to a second edge of the front face and a second edge of the rear face; and
(c) providing a closure for reversibly sealing a third edge of the front face to a third edge of the rear face.

15. The method of claim 14, wherein step (b) comprises thermal fusion bonding.

16. The method of claim 14, wherein step (b) comprises adhering the glove material to the sheet material using an adhesive.

17. The method of claim 14, wherein step (b) comprises ultrasonic welding.

18. The method of claim 14, wherein step (a) includes folding the sheet material about the first edge.

19. The method of claim 14, wherein step (a) includes stamping the front face and the rear face from the sheet material and bonding the first edge of the front face to the first edge of the rear face.

20. A method of making a device, comprising:
(a) providing a unitary front film including a front bag face and at least one front glove face integrally attached to at least one edge of the front bag face;
(b) providing a unitary rear film including a rear bag face and at least one rear glove face integrally attached to at least one edge of the rear bag face;
(c) sealingly joining a perimeter of the front film to a perimeter of the rear film, except along a closure edge of the front film and a closure edge of the rear film; and
(d) joining a closure to the closure edge of the front film and the closure edge of the rear film for reversibly sealing the device.

21. The method of claim 20, wherein:
step (c) forms a glove comprising the front glove face and the rear glove face, the glove having fingers extending away from the front bag face and the rear bag face, and
the method further comprises inverting the glove after step (d), so that the fingers of the glove are located between the front bag face and the rear bag face.

22. The method of claim 21, wherein step (a) includes stamping the unitary front film, and step (b) includes stamping the unitary rear film.

23. The method of claim 21, wherein step (c) includes thermal fusion bonding or ultrasonic welding.
